(19) United States
(12) Patent Application Publication
(10) Pub. No.: US 2024/0304366 A1
(43) Pub. Date: Sep. 12, 2024

(54) SOFT MAGNETIC METAL PARTICLE, DUST CORE, AND MAGNETIC COMPONENT

(71) Applicant: TDK Corporation, Tokyo (JP)

(72) Inventors: Ryoma NAKAZAWA, Tokyo (JP); Ryuichi WADA, Tokyo (JP); Yu SAKURAI, Tokyo (JP)

(73) Assignee: TDK Corporation, Tokyo (JP)

(21) Appl. No.: 18/594,115

(22) Filed: Mar. 4, 2024

(30) Foreign Application Priority Data
Mar. 6, 2023 (JP) 2023-033904

(51) Int. Cl. H01F 1/24; H01F 1/147

(52) U.S. Cl. CPC H01F 1/24; H01F 1/14766

(57) ABSTRACT

A soft magnetic metal particle may include a core particle and an insulating film over a surface of the core particle. The insulating film may include a complex oxide containing Si and B. B may constitute 1.0 mol % or more and 60.0 mol % or less of a total of Si and B in the insulating film.

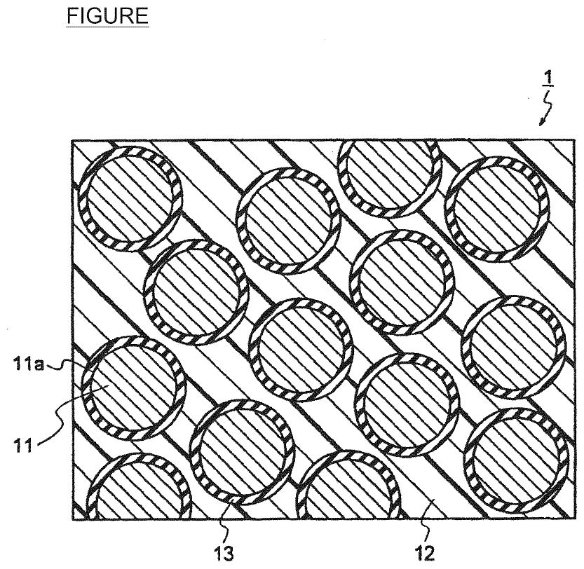

### CROSS-REFERENCE TO RELATED APPLICATION

The present application claims a priority to Japanese patent application No. 2023-033904 filed on Mar. 6, 2023, which is incorporated herein by reference in its entirety.

### BACKGROUND

The present disclosure relates to a soft magnetic metal particle, a dust core, and a magnetic component.

Patent Document 1 discloses a magnetic body including soft magnetic alloy grains containing Fe, element L (Si or Zr), and element M (a metal element other than Si or Zr that oxidizes more easily than Fe) as well as oxide film produced from oxidization of part of these grains. The oxide film has an inner film and an outer film having different compositions.
Patent Document 1: JP Patent Application Laid Open No. 2016-195152

### SUMMARY

A soft magnetic metal particle according to an aspect of the present disclosure includes:
a core particle; and
an insulating film over a surface of the core particle,
wherein
the insulating film includes a complex oxide containing Si and B; and
B constitutes 1.0 mol % or more and 60.0 mol % or less of a total of Si and B in the insulating film.

A dust core according to an aspect of the present disclosure includes the soft magnetic metal particle.

A magnetic component according to an aspect of the present disclosure includes the soft magnetic metal particle.

### BRIEF DESCRIPTION OF THE DRAWING(S)

The FIGURE is a schematic sectional view of a dust core according to an aspect of the present disclosure.

### DETAILED DESCRIPTION

Embodiments of the present disclosure are described below with reference to the drawing. The following embodiments of the present disclosure are exemplifications illustrative of the present disclosure. Various components, such as numerical values, shapes, materials, and manufacturing steps, according to the embodiments of the present disclosure can be modified or changed to the extent that technical problems do not arise.

Shapes and the like illustrated in the drawing of the present disclosure do not necessarily match actual shapes and the like, because the shapes and the like illustrated in the drawing may be modified for illustration purposes.

### <Soft Magnetic Metal Particle>

A soft magnetic metal particle according to an embodiment of the present disclosure includes a core particle 11 and an insulating film 13 over a surface 11a of the core particle 11, as illustrated in the FIGURE.

The core particle 11 is not limited as long as it contains a material that exhibits magnetism. The core particle 11 may contain Fe. When Fe is contained in the core particle 11 as a main component, saturation magnetization tends to be high. When Fe and Si are contained in the core particle 11 as a main component, initial permeability μi tends to be high. When Fe and Ni are contained in the core particle 11 as a main component, initial permeability μi tends to be high. When Fe and Co are contained in the core particle 11 as a main component, initial permeability μi tends to be high.

Note that, “contained in the core particle 11 as a main component” indicates that elements contained as a main component each constitute 1 wt % or more of the core particle 11; these elements contained as a main component constitute 40 wt % or more of the core particle 11 in total; and elements other than the elements contained as a main component each constitute a lower percentage of the core particle 11 than the element contained as a main component at a lowest percentage.

When the core particle 11 contains Fe as a main component, Fe constitutes 40 wt % or more of the core particle 11, and elements other than Fe each constitute a lower percentage of the core particle 11 than Fe. The elements other than the main component of the core particle 11 are not limited. Examples of the elements other than the main component (Fe) include Ni, Co, Si, Zr, V, Al, Nb, Ta, and Cr.

When the core particle 11 contains Fe and Si as a main component, Fe constitutes 1 wt % or more of the core particle 11; Si constitutes 1 wt % or more of the core particle 11; Fe and Si constitute 40 wt % or more of the core particle 11 in total; and elements other than Fe and Si each constitute a lower percentage of the core particle 11 than Fe or Si constituting a lower percentage. The elements other than the main component of the core particle 11 are not limited. Examples of the elements other than the main component (Fe and Si) include Ni, Co, Zr, V, Al, Nb, Ta, and Cr.

When the core particle 11 contains Fe or contains Fe and Si as a main component, Fe and Si may be contained in the core particle 11 at any content ratio. In some embodiments, Si/Fe=0/100 to 20/80 is satisfied in weight ratio. When Si/Fe=0/100 to 10/90 is satisfied in weight ratio, saturation magnetization tends to be high.

When the core particle 11 contains Fe and Ni as a main component, Fe constitutes 1 wt % or more of the core particle 11; Ni constitutes 1 wt % or more of the core particle 11; Fe and Ni constitute 40 wt % or more of the core particle 11 in total; and elements other than Fe and Ni each constitute a lower percentage of the core particle 11 than Fe or Ni constituting a lower percentage. The elements other than the main component of the core particle 11 are not limited. Examples of the elements other than the main component (Fe and Ni) include Co, Si, Zr, V, Al, Nb, Ta, and Cr.

When the core particle 11 contains Fe or contains Fe and Ni as a main component, Fe and Ni may be contained in the core particle 11 at any content ratio. In some embodiments, Ni/Fe=0/100 to 75/25 is satisfied in weight ratio.

When the core particle 11 contains Fe and Co as a main component, Fe constitutes 1 wt % or more of the core particle 11; Co constitutes 1 wt % or more of the core particle 11; Fe and Co constitute 40 wt % or more of the core particle 11 in total; and elements other than Fe and Co each constitute a lower percentage of the core particle 11 than Fe or Co constituting a lower percentage. The elements other than the main component of the core particle 11 are not limited. Examples of the elements other than the main component (Fe and Co) include Ni, Si, Zr, V, Al, Nb, Ta, and Cr.

When the core particle 11 contains Fe or contains Fe and Co as a main component, Fe and Co may be contained in the core particle 11 at any content ratio. In some embodiments, Co/Fe=0/100 to 50/50 is satisfied in weight ratio.

The insulating film 13 may not entirely cover the surface 11a of the core particle 11. In some embodiments, 90% or more of the entire surface 11a of the core particle 11 is covered.

The insulating film 13 contains Si oxide and B. As the insulating film 13 contains B in addition to the Si oxide, relative permittivity ε of a dust core 1 can be reduced while initial permeability μi of the dust core 1 at high frequencies is maintained.

The Si oxide in the insulating film 13 is not limited as long as the Si oxide includes a complex oxide containing Si and B.

The Si oxide in the insulating film 13 is, for example, Si—O based oxide (silicon oxide). Any Si—O based oxide may be used. For example, Si oxide such as SiO₂ or a complex oxide containing Si and other elements may be used.

B is contained in the insulating film 13 as a complex oxide containing B and Si. That is, the insulating film 13 includes the complex oxide containing Si and B. As B is contained in the insulating film 13 as the complex oxide containing B and Si, relative permittivity ε of the dust core 1 can be reduced while initial permeability μi of the dust core 1 at high frequencies is maintained. In other words, the ratio (μi/ε) of initial permeability to relative permittivity, which is an indicator of impedance frequency characteristics, can be increased.

B constitutes 1.0 mol % or more and 60.0 mol % or less of the total of Si and B in the insulating film 13 (the ratio of B in the insulating film 13 to the total of Si and B in the insulating film 13 may be referred to as B/(Si+B) below). As B/(Si+B) of the insulating film 13 is 1.0 mol % or more and 60.0 mol % or less, relative permittivity ε of the dust core 1 can be reduced while initial permeability μi of the dust core 1 at high frequencies is maintained. B/(Si+B) of the insulating film 13 may be 5.0 mol % or more and 50.0 mol % or less, or may be 10.0 mol % or more and 30.0 mol % or less. As B/(Si+B) falls within the above-mentioned range, relative permittivity ε of the dust core 1 is further readily reduced, which can increase μi/E.

A method of confirming that the insulating film 13 includes the complex oxide containing Si and B is described below.

When the insulating film 13 includes the complex oxide containing Si and B, Si and B are uniformly present in the insulating film 13. That Si and B are uniformly present in the insulating film 13 can be confirmed by, for example, a line analysis along a depth direction of the insulating film 13. In this specification, the depth direction means the film thickness direction, i.e., the direction from a surface (an outer surface) opposite a surface of the insulating film 13 on the core particle 11 side to the latter surface.

For example, provided below is description of the line analysis of the insulating film 13 having a B/(Si+B) of 30 mol % starting from the outer surface (0 nm) of the insulating film 13.

When the insulating film 13 includes the complex oxide containing Si and B, measurement of any portions of the insulating film 13 finds that B readily constitutes 30 mol % of the total of Si and B in the insulating film 13. That is, measurement of any portions where B and/or Si contained in the insulating film 13 are detected finds that B readily constitutes the same percentage of the total of Si and B in the insulating film 13. It is assumed that this is because Si and B are uniformly combined to form the complex oxide.

For example, when the insulating film 13 has a thickness of 75 nm or more and less than 80 nm, results of the line analysis tend to be as shown in Table A. In Table A, the B column shows the percentages of B in the total of Si and B, and the Si column shows the percentages of Si in the total of Si and B.

TABLE A

| Analysis distance | B | Si |
|---|---|---|
| (nm) | (mol %) | (mol %) |
| 0 | 30 | 70 |
| 10 | 30 | 70 |
| 40 | 30 | 70 |
| 45 | 30 | 70 |
| 50 | 30 | 70 |
| 60 | 30 | 70 |
| 70 | 30 | 70 |
| 75 | 30 | 70 |
| 80 | 0 | 0 |
| 100 | 0 | 0 |

By contrast, when B is scattered in the insulating film 13 in form of a simple substance or a compound (excluding the complex oxide containing Si and B), portions where Si alone is detected and portions where B alone is detected tend to be individually included in the insulating film 13.

For example, when the insulating film 13 has a thickness of 75 nm or more and less than 80 nm, results of the line analysis tend to be as shown in Table B. In Table B, the B column shows the percentages of B in the total of Si and B, and the Si column shows the percentages of Si in the total of Si and B.

TABLE B

| Analysis distance | B | Si |
|---|---|---|
| (nm) | (mol %) | (mol %) |
| 0 | 0 | 100 |
| 10 | 0 | 100 |
| 40 | 0 | 100 |
| 45 | 100 | 0 |
| 50 | 100 | 0 |
| 60 | 0 | 100 |
| 70 | 0 | 100 |
| 75 | 0 | 100 |
| 80 | 0 | 0 |
| 100 | 0 | 0 |

When the insulating film 13 includes the complex oxide containing Si and B, portions where B or Si constitutes 0.10 mol % or less of the total of Si and B in the insulating film 13 account for less than 10% of the insulating film 13. When the insulating film 13 substantially does not include the complex oxide containing Si and B, portions where B or Si constitutes 0.10 mol % or less of the total of Si and B in the insulating film 13 account for 10% or more of the insulating film 13. This can be confirmed by, for example, element mapping using TEM-electron energy-loss spectroscopy (TEM-EELS).

In some embodiments, the insulating film 13 contains a metal element in addition to B. Examples of metal elements include Ba, Ca, Mg, Al, Ni, Mn, Zn, Zr, Ti, Nb, and Ta. Among these, Ca, Mg, Ni, Mn, Zn, Zr, Ti, Nb, and Ta are relatively easy to be introduced in the insulating film. However, when the insulating film 13 contains these metal elements without containing B, it cannot be expected that various properties of the dust core 1 simultaneously become suitable. Contents of the metal elements are not limited. The contents of the metal elements are each, for example, 1 mol % or less with respect to the B content.

Further, the insulating film 13 may contain a non-metal element in addition to B. For example, C, N, or P may be contained. The insulating film 13 can substantially not contain F (fluorine). When the insulating film 13 substantially does not contain F, F constitutes 0.10 mol % or less with respect to the total of Si and B in the insulating film 13. The insulating film 13 can substantially not contain BN (boron nitride). When the insulating film 13 substantially does not contain BN, BN constitutes 0.10 mol % or less with respect to the total of Si and B in the insulating film 13.

The insulating film 13 is not a film with low compactness or low uniformity (e.g., a film in which powdery and/or fibrous material is accumulated) but is a film with high compactness and high uniformity.

The insulating film 13 may have any thickness. The thickness of the insulating film 13 is, for example, 5 nm or more and 500 nm or less. In some embodiments, the thickness of the insulating film 13 is 100 nm or more and 200 nm or less. In particular, when the thickness of the insulating film 13 is 100 nm or more and 200 nm or less, μi/e can be further increased.

The insulating film 13 may exhibit crystallinity. Any method may be used for confirming whether the insulating film 13 exhibits crystallinity. For example, when it is confirmed that the insulating film 13 has a lattice fringe attributed to a periodic array in observation of the insulating film 13 with a high-resolution electron microscope, it can be determined that the insulating film 13 exhibits crystallinity.

The insulating film 13 may be a single-layer film. Any method of confirming whether the insulating film 13 is a single-layer film may be used. For example, when a section of the soft magnetic metal particle is observed with STEM-EELS, TEM-EELS, or the like, difference in brightness or contrast may be used to confirm that the insulating film 13 does not include two or more layers. With results of a composition analysis of the insulating film 13, compositional difference may be used to confirm that the insulating film 13 does not include two or more layers.

When whether the insulating film 13 is a single-layer film is determined, a film (layer) having a thickness that is 3% or less of the thickness of the insulating film 13 is not taken into account.

The insulating film 13 is formed directly or indirectly over the surface of the core particle 11. That is, the insulating film 13 may be in contact with the surface 11a of the core particle 11, or a film other than the insulating film 13 may be interposed between the surface 11a of the core particle 11 and the insulating film 13.

The film other than the insulating film 13 interposed between the surface 11a of the core particle 11 and the insulating film 13 may be made from any material. For example, SiO₂ may be used. When the film other than the insulating film 13 is interposed between the surface 11a of the core particle 11 and the insulating film 13, the film other than the insulating film 13 may have a thickness that is 50% or less of the thickness of the insulating film 13.

A film other than the insulating film 13 may be in contact with the outer surface of the insulating film 13.

The film other than the insulating film 13 and in contact with the outer surface of the insulating film 13 may be made from any material. For example, SiO₂ may be used. When the film other than the insulating film 13 is in contact with the outer surface of the insulating film 13, this film other than the insulating film 13 may have a thickness that is 50% or less of the thickness of the insulating film 13.

The insulating film 13 may not entirely cover the surface 11a of the core particle 11. In some embodiments, 90% or more of the entire surface 11a of the core particle 11 is covered.

The soft magnetic metal particle of the present disclosure may be used for any purpose or usage. For example, the soft magnetic metal particle may be used for a magnetic component. Examples of magnetic components include dust cores.

### <Dust Core>

A dust core according to an embodiment of the present disclosure includes the above soft magnetic metal particles. The dust core 1 according to the embodiment of the present disclosure includes a grain boundary phase 12 between the soft magnetic metal particles as illustrated in the FIGURE. The grain boundary phase 12 may include any compound. For example, silicone resin, epoxy resin, imide resin, and/or Si—O based oxide may be included. In some embodiments, the grain boundary phase 12 has pores. Examples of silicone resin that may be included in the grain boundary phase 12 include methyl based silicone resin. Examples of epoxy resin include cresol novolac resin. Examples of imide resin include bismaleimide resin.

A heat treatment described later may cause the silicone resin included in the grain boundary phase 12 to be partly or entirely changed into Si—O based oxide (e.g., SiO₂).

The dust core 1 may include any amount of core particles 11, and the grain boundary phase 12 may include any amount of the compound. In some embodiments, the core particles 11 constitute 90 wt % to 99.9 wt % of the dust core 1 in its entirety. In some embodiments, the compound in the grain boundary phase 12 constitutes 0.1 wt % to 10 wt % of the dust core 1 in its entirety.

Similarly to the insulating film 13, the grain boundary phase 12 may contain B.

Any method of observing a section of the dust core 1 may be used. For example, a SEM or a TEM may be used at an appropriate magnification to observe the dust core 1. Further, an EELS analysis enables measurement of the composition, particularly the B content and the Si content, of portions of the dust core 1. Moreover, B/(Si+B) of the insulating film 13 can be measured.

### <Manufacturing Method>

A method of manufacturing the soft magnetic metal particles and the dust core 1 is described below, but the method of manufacturing the soft magnetic metal particles and the dust core 1 is not limited the following method.

First, the core particles 11 are prepared. Any method of producing the core particles 11 is used, such as a gas atomization method and a water atomization method. The core particles 11 may have any particle size and any circularity. When the particle size has a median value (D50) of 1 μm to 100 μm, initial permeability μi tends to be high.

Next, coating is performed for providing the surface 11a of each of the core particles 11 with the insulating film 13 containing the Si oxide and B. Any coating method may be used, such as a method of applying a coating solution containing alkoxysilane and alkoxyborane to the core particles 11. Any method of applying the coating solution to the core particles 11 may be used, such as a spray diffusion method. Alkoxyborane of any condition may be contained in the coating solution.

A method of producing the coating solution containing alkoxysilane and alkoxyborane is described below.

First, alkoxysilane is provided. Examples of alkoxysilane include mono-alkoxysilane, dialkoxysilane, trialkoxysilane, and tetraalkoxysilane. Examples of mono-alkoxysilane include trimethylmethoxysilane, trimethylethoxysilane, and trimethyl(phenoxy)silane. Examples of dialkoxysilane include dimethyldimethoxysilane, dimethyldiethoxysilane, diisopropyldimethoxysilane, diisobutyldimethoxysilane, t-butyl-methyl-dimethoxysilane, and t-butyl-methyl-diethoxysilane. Examples of trialkoxysilane include ethyltrimethoxysilane, ethyltriethoxysilane, vinyltrimethoxysilane, methyltrimethoxysilane, n-propyltriethoxysilane, decyltrimethoxysilane, decyltriethoxysilane, and phenyltrimethoxysilane. Examples of tetraalkoxysilane include tetramethoxysilane, tetraethoxysilane, tetrapropoxysilane, and tetraisopropoxysilane. One type of alkoxysilane or a combination of two or more types of alkoxysilane may be used as alkoxysilane.

Next, alkoxysilane is dissolved in a solvent. The solvent may be any type of alcohol. Examples of alcohol include ethanol and isopropyl alcohol.

Alkoxyborane is separately prepared and is added to the solvent in which alkoxysilane has dissolved. Any alkoxyborane may be used. Examples of alkoxyborane include trimethoxyborane, triethoxyborane, triisopropoxyborane, and tributoxyborane.

Further adding water gives the coating solution containing alkoxysilane and alkoxyborane.

Controlling the ratio of alkoxysilane to alkoxyborane can control B/(Si+B) of the insulating film 13 eventually obtained.

The coating solution may have any alkoxysilane concentration. The alkoxysilane concentration is determined based on the intended thickness or the like of the insulating film 13.

At the time of spray diffusion, the ratio of alkoxysilane to the total amount of the core particles 11 may be 0.1 to 5 parts by weight/100 parts by weight. The more alkoxysilane, the larger tends to be the thickness of the insulating film 13.

Although spray diffusion may be carried out under any conditions, carrying out spray diffusion while performing a heat treatment at 50° C. to 90° C. readily accelerates a sol-gel reaction forming the insulating film 13.

Removing the solvent by drying the core particles 11 to which the coating solution has been spray-diffused and then heating the core particles 11 at 200° C. to 400° C. for 1 hour to 10 hours accelerate the sol-gel reaction to form the insulating film 13 containing the Si oxide and B. At this time, the higher the heating temperature and the longer the heating time, the higher tends to be the density of the insulating film 13. The core particles 11 may be granulated using a mesh sieve before being heated.

Next, a resin solution is produced, if the grain boundary phase 12 of a compact body prior to the heating treatment described later includes resin. In the resin solution, the above-mentioned silicone resin, epoxy resin, and/or imide resin as well as a hardener may be included. Any hardener may be used, such as epichlorohydrin. Any solvent may be used for the resin solution. The solvent may be a volatile solvent, such as acetone and ethanol. Provided that the entire resin solution is 100 wt %, the total concentration of the resin and the hardener is, for example, 10 wt % to 80 wt %.

When the grain boundary phase 12 contains B, B is further added to the resin solution at this time. B of any state may be contained in the resin solution.

Next, the core particles 11 each having the insulating film 13, i.e., the soft magnetic metal particles, and the resin solution are mixed. Then, the solvent of the resin solution is volatilized to give granules. The granules may directly fill a mold or may be granulated to fill the mold. When the granules are granulated, any granulation method may be used. For example, a mesh sieve with an opening of 45 to 500 μm may be used.

Next, the mold having a predetermined shape is filled with the granulated granules, and pressure is applied thereto to give the compact body. The applied pressure (molding pressure) is not limited and can be, for example, 500 to 1500 MPa. The higher the molding pressure, the higher the initial permeability μi of the dust core 1 eventually obtained.

The compact body may be the dust core. Alternatively, the compact body may be subject to a heat treatment, and a resulting sintered body may be the dust core. Conditions of the heat treatment are not limited. When silicone resin is used as the resin, the heat treatment may be performed under conditions at which the silicone resin is sintered. For example, the heat treatment may be performed at 400° C. to 1000° C. for 0.1 to 10 hours. The heat treatment may be performed in any atmosphere, such as air or a nitrogen atmosphere.

Although the description of the dust core according to the present embodiment and the method of manufacturing the same is provided above, the dust core of the present disclosure and the method of manufacturing the same are not limited to those of the above embodiment.

The dust core of the present disclosure may be used for any purpose or usage. For example, the dust core may be used for magnetic components, such as inductors, reactors, choke coils, and transformers. A magnetic component according to an embodiment of the present disclosure includes the above dust core.

The soft magnetic metal particles of the present disclosure can be suitably used for magnetic components, such as thin film inductors and magnetic heads. Moreover, the magnetic components including the soft magnetic metal particles can be suitably used for electronic devices.

### Examples

Hereinafter, the present disclosure is described based on further detailed examples. However, the present disclosure is not limited to the examples.

### <Production of Soft Magnetic Metal Powder>

As metal magnetic particles (core particles), Fe—Si based metal particles (metal particles containing Fe and Si as a main component) in which Si/Fe=4.5/95.5 in weight ratio was satisfied and Fe and Si constituted 99 wt % or more of the particles in total were produced using a gas atomization method. These Fe—Si based metal particles had a median particle size (D50) of 3 μm.

Next, a coating solution for forming an insulating film on surfaces of the metal magnetic particles was produced. First, with respect to 100 parts by weight of the metal magnetic particles (total), 15 parts by weight of ethanol and trimethoxysilane were mixed. Then, tributoxyborane was added thereto and was mixed therewith. Then, 2.0 parts by weight of purified water was added thereto and was mixed therewith. The ratio of trimethoxysilane to tributoxyborane was determined so that B/(Si+B) of the coating film eventually obtained was as shown in Table 1. Also, the total content of trimethoxysilane and tributoxyborane was determined so that the thickness of the insulating film eventually obtained was as shown in Tables 1 and 2.

At this time, the coating solutions of Comparative Examples 2 and 3 were cloudy and non-uniform. Other coating solutions were clear and uniform.

The metal magnetic particles and the coating solution were mixed and were subject to a heat treatment during spray diffusion. The heat treatment temperature was 70° C., and the heat treatment time was 10 hours. Further, drying after the heat treatment gave metal magnetic particles having the insulating film over their surfaces.

The resulting metal magnetic particles were granulated with a 140-mesh sieve and were then subject to another heat treatment. The heat treatment temperature was 300° C., and the heat treatment time was 5 hours.

### <Production of Toroidal Cores>

As many number of toroidal cores as necessary for measurement of initial permeability μi, measurement of relative permittivity ε, and observation of the microstructure of the soft magnetic metal particles were produced.

Silicone resin and acetone were mixed to produce a resin solution. As silicone resin, Shin-Etsu Silicone KR-242A (manufactured by Shin-Etsu Chemical Co., Ltd.) was used. Silicone resin and acetone were mixed to satisfy a weight ratio of 34:66.

Provided that the resulting soft magnetic metal particles of each Example or Comparative Example accounted 100 parts by weight, 6 parts by weight of the above resin solution was added to the soft magnetic metal particles and were mixed therewith. Then, the mixture was dried so that acetone was volatilized to give granules. The granules were granulated using a 42-mesh sieve. The resulting granules were dried on a 50° C. hot plate for 0.5 hours to produce a granulated powder.

0.1 parts by weight of zinc stearate was added to 100 parts by weight of the dried granulated powder, and molding was performed. The amount of the granulated powder with which a mold was filled was 5 g. The molding pressure was appropriately controlled so that the toroidal cores eventually obtained had a density of about 5.8 g/cm³. The mold had a toroidal shape with an outer diameter @ of 17.5 mm, an inner diameter @ of 10.0 mm, and a thickness of 4.8 mm.

Resulting toroidal cores were subject to a heat treatment at 700° C. for 1 hour to give the toroidal cores. Provided that each entire dust core eventually obtained was 100 wt %, the soft magnetic metal particles constituted about 98 wt % of the dust core.

### <Confirmation of Structure of Insulating Film>

Through TEM-EELS observation, it was confirmed that the metal magnetic particles had the insulating film covering them. Moreover, it was confirmed that B was contained substantially only in the insulating film. Further, B/(Si+B) of the insulating film was quantified with EELS. Ten measurement points were determined in the insulating film 13, and values of B/(Si+B) at the respective measurement points were averaged. Table 1 shows the results. Note that each measurement point had a size of 1 nm².

Also, it was confirmed that, in all Examples and Comparative Examples 2 and 3, portions where B or Si constituted 0.10 mol % or less of the total of Si and B in the insulating film accounted for less than 10% of the insulating film. That is, it was confirmed that the insulating film included a complex oxide containing Si and B.

The thickness of the insulating film was measured through TEM observation. Measurement points were determined at a surface of the metal magnetic particles. Then, a perpendicular line was drawn from each measurement point into the insulating film, and a length of the perpendicular line within the insulating film was deemed to be the thickness of the insulating film at that measurement point. Ten measurement points were determined, and the thickness of the insulating film was measured at each measurement point. An average of the measured thickness of the insulating film was deemed to be the thickness of the insulating film of the metal magnetic particles. It was confirmed that, in Examples and Comparative Example 1, the thickness of the insulating film was about as shown in Tables 1 and 2. Note that, in Comparative Examples 2 and 3, the thickness of the insulating film was not measured, because the insulating film had a significantly low uniformity and had a coverage of less than 50% over the surfaces of the core particles.

It was confirmed that the insulating film of the soft magnetic metal particles of each Example or each Comparative Example exhibited crystallinity. Specifically, the soft magnetic metal particles were observed with a high-resolution electron microscope, and it was confirmed that the insulating film had a lattice fringe attributed to a periodic array.

The density of the toroidal cores was calculated using dimensions and weight of the resulting dust cores. In all Examples and Comparative Examples, it was confirmed that the density was about 5.8 g/cm³.

<Measurement of Initial Permeability μi>

A wire being wound around the toroidal cores for 50 turns, the initial permeability μi of the toroidal cores was measured with an LCR meter (Agilent RF Impedance/Material Analyzer E4991A). The measurement frequency was 500 MHz. Tables 1 and 2 show the results. An initial permeability μi of 13.0 or more and less than 14.0 was deemed good, and an initial permeability μi of 14.0 or more was deemed better.

### <Production of Disc Core>

A disc core was produced under conditions similar to those of the toroidal cores except that the molding pressure was appropriately controlled so that the disc core eventually obtained had a density of about 5.8 g/cm³ and that a mold had a disc shape having a diameter Φ of 10 mm and a thickness of 2 mm.

### <Measurement of Relative Permittivity ε>

Capacitance was measured at room temperature (25° C.) using an LCR meter (HEWLETT PACKARD/PRECISION LCR METER 4285A) after an In—Ga paste was applied to both surfaces of the disc core to form terminal electrodes. Using the measured capacitance, relative permittivity was calculated. The measurement frequency was 1 MHz, and the measurement voltage was 1 Vrms. Tables 1 and 2 show the results. A relative permittivity ε of 45.0 or more and 55.0 or less was deemed good, and a relative permittivity ε of less than 45.0 was deemed better.

Using measurement results of initial permeability and relative permittivity, μi/ε was calculated. 0.300≤μi/ε<0.350 was deemed good, and 0.350≤μi/ε was deemed better.

TABLE 1

| | | Film | | | |
|---|---|---|---|---|---|
| Example/ | B/(Si + | thickness/ | | | μi/ |
| Comparative Example | B)/mol % | nm | μi | ε | ε |
| Comparative Example 1 | 0 | 150 | 16.3 | 63.5 | 0.257 |
| Example 1 | 1 | 150 | 15.4 | 49.1 | 0.314 |
| Example 2 | 3 | 150 | 15.1 | 48.9 | 0.309 |
| Example 3 | 5 | 150 | 15.0 | 48.0 | 0.313 |
| Example 4 | 10 | 150 | 15.2 | 42.0 | 0.362 |
| Example 5 | 15 | 150 | 15.5 | 43.9 | 0.353 |
| Example 6 | 20 | 150 | 15.2 | 43.3 | 0.351 |
| Example 7 | 30 | 150 | 15.0 | 42.5 | 0.353 |
| Example 8 | 50 | 150 | 15.2 | 47.2 | 0.322 |
| Example 9 | 60 | 150 | 15.2 | 49.1 | 0.310 |
| Comparative Example 2 | 65 | — | 17.3 | 58.0 | 0.298 |
| Comparative Example 3 | 70 | — | 19.4 | 111.0 | 0.175 |

TABLE 2

| | | Film | | | |
|---|---|---|---|---|---|
| Example/ | B/(Si + | thickness/ | | | μi/ |
| Comparative Example | B)/mol % | nm | μi | ε | ε |
| Example 10 | 10 | 90 | 17.1 | 49.2 | 0.348 |
| Example 11 | 10 | 100 | 16.5 | 41.9 | 0.394 |
| Example 4 | 10 | 150 | 15.2 | 42.0 | 0.362 |
| Example 12 | 10 | 200 | 14.1 | 39.2 | 0.360 |
| Example 13 | 10 | 210 | 13.5 | 38.7 | 0.349 |

Table 1 shows Examples and Comparative Examples in which B/(Si+B) of the insulating film was changed. In each Example, in which the insulating film had a B/(Si+B) of 1.0 or more and 60.0 or less, initial permeability μi and relative permittivity ε were good, and μi/e was good being 0.300 or more.

In Comparative Example 1, in which the thickness of the insulating film was the same as Examples but B/(Si+B) was too low, relative permittivity ε was too high compared to each Example.

In Comparative Example 2 and 3, in which B/(Si+B) of the insulating film was too high, relative permittivity ε was too high compared to each Example. It is assumed that this was attributed to excessive local increase of the core density because of the coating solutions being cloudy and non-uniform.

Table 2 shows Examples in which the thickness of the insulating film of Example 4 of Table 1 was changed. Even when the thickness of the insulating film changed within a range of 100 to 200 nm, initial permeability μi and relative permittivity ε were good, and μi/ε was better being 0.350 or more.

### Additional Notes

The technology of the present disclosure includes the following example configurations but may include any other configurations.
[1] A soft magnetic metal particle includes:
a core particle; and
an insulating film over a surface of the core particle,
in which
the insulating film includes a complex oxide containing Si and B; and
B constitutes 1.0 mol % or more and 60.0 mol % or less of a total of Si and B in the insulating film.
[2] The soft magnetic metal particle according to [1], in which the core particle includes

### Fe.

[3] The soft magnetic metal particle according to [1] or [2], in which the insulating film exhibits crystallinity.
[4] The soft magnetic metal particle according to any one of [1] to [3], in which the insulating film includes a single-layer film.
[5] The soft magnetic metal particle according to any one of [1] to [4], in which B constitutes 10.0 mol % or more and 30.0 mol % or less of the total of Si and B in the insulating film.
[6] The soft magnetic metal particle according to any one of [1] to [5], in which the insulating film has a thickness of 100 nm or more and 200 nm or less.
[7] A dust core includes the soft magnetic metal particle according to any one of [1] to [6].
[8] A magnetic component includes the soft magnetic metal particle according to any one of [1] to [6].

### REFERENCE NUMERALS

1 . . . dust core
11 . . . metal magnetic particle (core particle)
11a . . . surface of a metal magnetic particle
12 . . . grain boundary phase
13 . . . insulating film

What is claimed is:

1. A soft magnetic metal particle comprising:
a core particle; and
an insulating film over a surface of the core particle,
wherein
the insulating film comprises a complex oxide containing Si and B; and
B constitutes 1.0 mol % or more and 60.0 mol % or less of a total of Si and B in the insulating film.

2. The soft magnetic metal particle according to claim 1, wherein the core particle comprises Fe.

3. The soft magnetic metal particle according to claim 1, wherein the insulating film exhibits crystallinity.

4. The soft magnetic metal particle according to claim 1, wherein the insulating film comprises a single-layer film.

5. The soft magnetic metal particle according to claim 1, wherein B constitutes 10.0 mol % or more and 30.0 mol % or less of the total of Si and B in the insulating film.

6. The soft magnetic metal particle according to claim 1, wherein the insulating film has a thickness of 100 nm or more and 200 nm or less.

7. The soft magnetic metal particle according to claim 1, wherein the insulating film covers 90% or more of an entire surface of the core particle.

8. The soft magnetic metal particle according to claim 1, wherein the insulating film covers an entire surface of the core particle.

9. The soft magnetic metal particle according to claim 1, wherein the insulating film does not substantially contain fluorine.

10. The soft magnetic metal particle according to claim 1, wherein the insulating film does not substantially contain boron nitride.

11. The soft magnetic metal particle according to claim 1, wherein the insulating film further comprises at least one of non-metal elements of C, N, or P.

12. The soft magnetic metal particle according to claim 1, wherein the insulating film further comprises at least another metal element selected from the group consisting of Ba, Ca, Mg, Al, Ni, Mn, Zn, Zr, Ti, Nb, and Ta.

13. The soft magnetic metal particle according to claim 12, wherein a content of the another metal element is 1 mol % or less with respect to a content of B.

14. The soft magnetic metal particle according to claim 1, wherein the insulating film is in direct contact with the surface of the core particle.

15. The soft magnetic metal particle according to claim 1, wherein another film other than the insulating film is interposed between the surface of the core particle and the insulating film.

16. The soft magnetic metal particle according to claim 15, wherein the another film has a thickness 50% or less of a thickness of the insulating film.

17. The soft magnetic metal particle according to claim 15, wherein the another film comprises SiO₂.

18. The soft magnetic metal particle according to claim 1, wherein a median value D50 particle size of the core particle is in a range of 1 μm to 100 μm.

19. A dust core comprising the soft magnetic metal particle according to claim 1.

20. A magnetic component comprising the soft magnetic metal particle according to claim 1.
